(19) United States
(12) Patent Application Publication
(10) Pub. No.: US 2012/0023941 A1
(43) Pub. Date: Feb. 2, 2012

(54) Turbo boosted thermal flex blanket solar electric generator

(76) Inventor: Nemours Peter Holec, Chandler, AZ (US)

(21) Appl. No.: 12/804,809

(22) Filed: Jul. 29, 2010

(51) Int. Cl. F03G 6/00

(52) U.S. Cl. 60/641.8

(57) ABSTRACT

The solar heated gas vapor (A) from the collector blanket (1) is compressed by impellor (2) to raise its temperature sufficiently to vaporize a secondary liquid (C) refrigerant in a boiler (4). Vapor (A) exits boiler (4) and drives expansion rotor (5) to assist motor (11) and enters condenser (6) to condense vapor (B) into liquid (C) and exits to return to collector blanket. Liquid (C) is injected by pump (7) into boiler (4) as required by level control (17) and is boiled into vapor (B) which rises in super heater (3) and enters expansion rotor (8) to drive generator (10). Vapor (B) exits to enter brine chiller (9) to cool brine. Vapor (B) leaves brine chiller and enters condenser (6) to be condensed into liquid (C) and is pumped back to boiler (4) as needed.

### CROSS-REFERENCE TO RELATED APPLICATIONS

Not applicable.

### FEDERALLY SPONSORED RESEARCH

Not applicable.

### SEQUENCE LISTING OR PROGRAM

Not applicable.

### BACKGROUND

1. Field of Invention

Conversion of solar thermal radiation into electrical power generation.

2. Background-Prior Art

Currently, parabolic mirrors, troughs, magnifiers and Fresnel lenses are used to concentrate solar heat to boil water or heat primary fluids to boil water to make steam to drive a piston or turbine to turn a generator. All these methods require dust and dirt free ambiance and solar tracking mechanisms and the constraints of reflective and focusing devices and discharging waste solar heat to atmosphere. Water Treatment, condenser cleaning, high TDS blow down of cooling water, cooling tower maintenance all add costs to electrical power generation. Photo Voltaic panels generate 9 to 15 percent solar efficiency.

### SCOPE, CONCLUSIONS

Conundrum: If 3413 BTU per KW of electricity is required to absorb 11000 BTU's of heat energy, as in a refrigeration circuit, why can't 11000 BTU's of solar radiation be converted into 1 KW of electricity?

In the process of compressing 11000 BTU's with 3413BTU's of electricity to a higher heat level, instead of dispersing to environment, it can be used to generate pressure in a boiler like burning fossil fuel to boil water.

Proposal: Collect solar radiation in a flexible refrigerant vapor filled blanket and compress heated vapor to evaporate a saturated liquid in a separate boiler circuit. The liquids' vapor is additionally superheated to prevent condensation in the expansion rotor (turbine). This involves one compressor and two expansion rotors connected to a motor and generator. Volumetric displacement of compressor should be at least twice that of energy recovery expansion rotor*, i.e. motor coupled rotor. The generator expansion rotor size is computer modeled. Two distinct refrigerant circuits are required. One dry (low pressure) for the solar collector circuit and one for the saturated (high pressure) boiler loop**. Three heat exchangers are also required to evaporate, condense, and superheat refrigerants. The motor is used to start dry gas compression and generator delivers DC power to an alternating current conditioner.

The work of compressing solar heated vapor for heat transfer is used to drive an expansion rotor* to assist the motor. A fourth heat exchanger may be connected as a brine chiller.

Notes: *—Compression and expansion rotors can be either turbo super chargers or scroll design compressors.

**—Choice of refrigerants governs the pressures in each circuit.

### ADVANTAGES

High temperatures confined to boiler heat exchanger and compressor.
Low temperatures are limited to collector blanket
Dirt and dust accumulations not a problem.
All components readily available.
No reflective or focusing elements required.
No water usage.
No waste heat as in nuclear power generation.
No stack emissions as in fossil fuel power generation.
Labor intensive for production of this apparatus.
Counteracts symptoms of global warming.

### SUMMARY

My embodiment circumvents all the aforementioned problems, weaknesses, and difficulties by compressing and decompressing a primary gas (vapor) from a moderately heated solar blanket to heat exchangers which in turn vaporize a secondary liquid to drive impellors that spin a generator.

### DRAWINGS

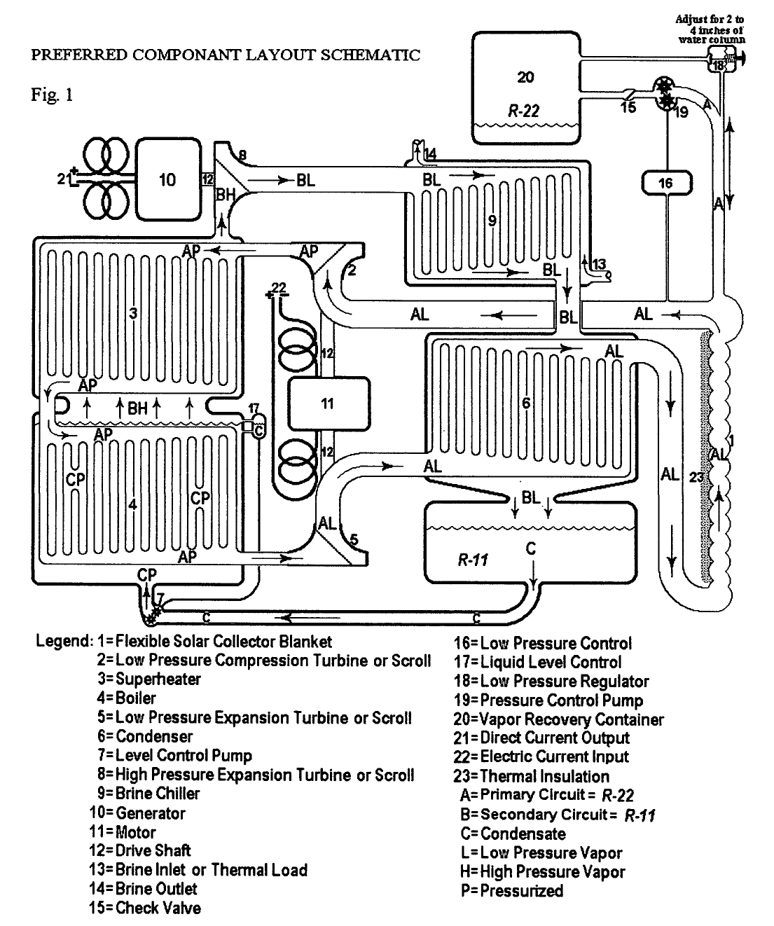

### Reference Numerals Common to FIGS. 1, 2, and 3

FIG. 1 Shows a plan layout of Preferred Embodiment with brine chiller.

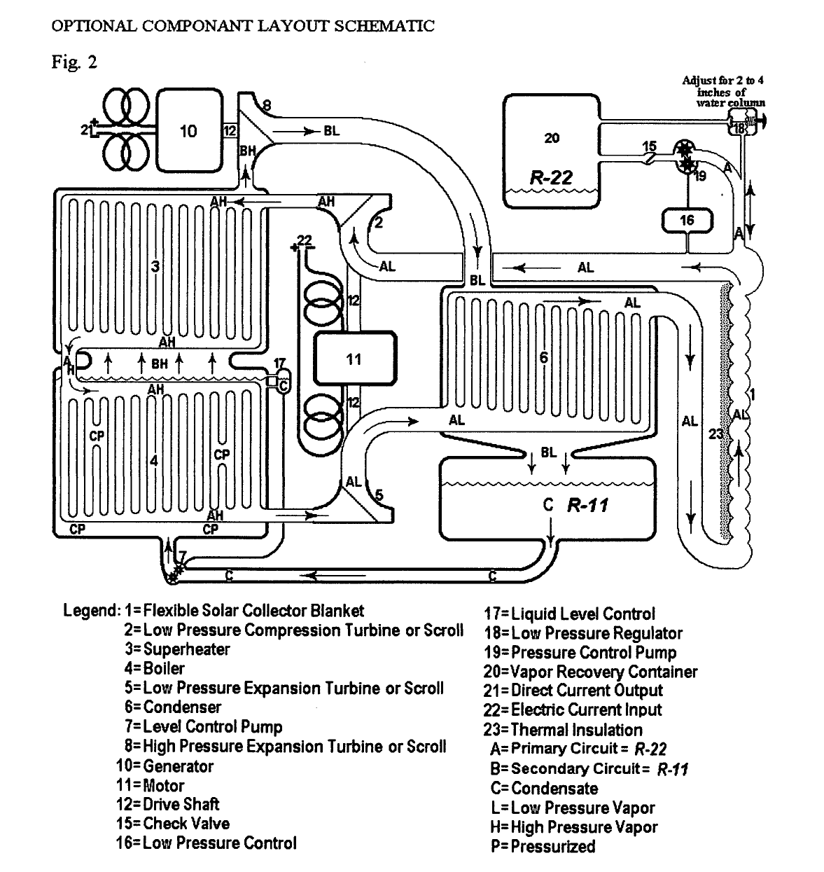

FIG. 2 Shows a plan layout of Optional Embodiment without brine chiller.

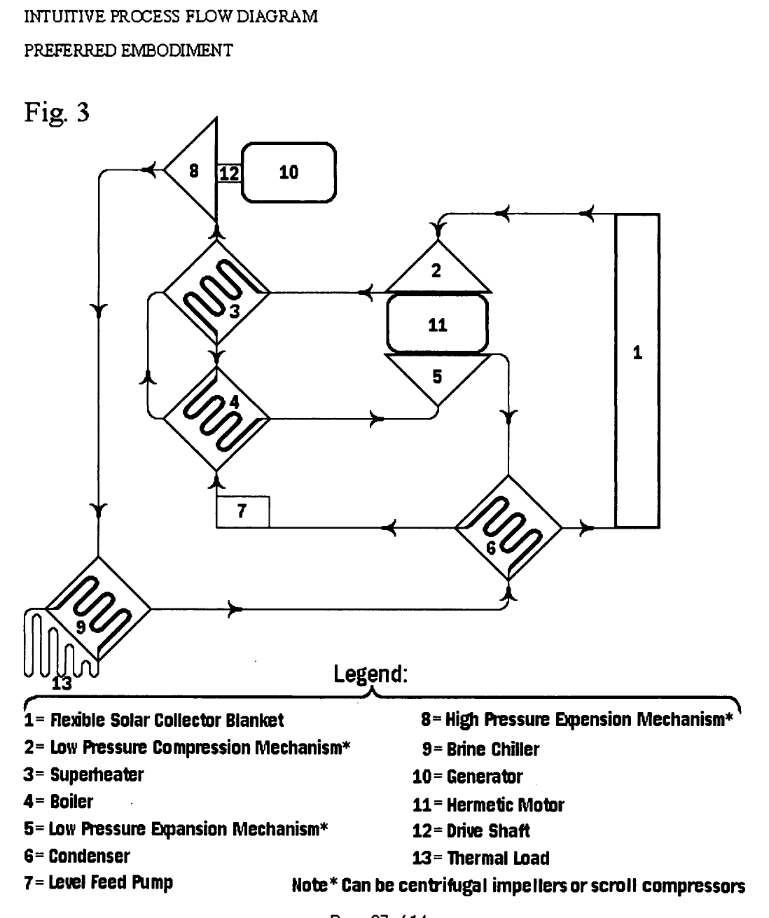

FIG. 3 Is a simplified Process Flow diagram (minus modifications).

Legend:

```
  1 = Flexible Solar Collector Blanket
  2 = Low Pressure Compression Turbine or Scroll
  3 = Superheater Heat Exchanger
  4 = Boiler Heat Exchanger
  5 = Low Pressure Expansion Turbine or Scroll
  6 = Condenser Heat Exchanger
  7 = Level Control Pump
  8 = High Pressure Expansion Turbine or Scroll
  9 = Brine Chilling Heat Exchanger
10 = Generator
11 = Motor
12 = Drive Shaft
13 = Brine Inlet or Thermal Load
14 = Brine Outlet
15 = Check Valve
16 = Low Pressure Control
17 = Liquid Level Control
18 = Low Pressure Regulator
19 = Pressure Control Pump
20 = Vapor Recovery Tank
21 = Direct Current Output
22 = Electrical Current Input
23 = Thermal Insulation
A = Primary (dry) Circuit “R = 22”
B = Secondary (saturated) Circuit “R11”
C = Condensate
L = Low Pressure Vapor
H = High Pressure Vapor
P = Pressurized
```

SEQUENCE OF OPERATION: Re. pages 05, 06, 07=FIGS. 1, 2, 3
The system utilizes two separate vapor circuits. Primary circuit “A” is a dry loop. Secondary circuit “B” is a wet or saturated loop.

Regarding the dry vapor loop “A” only. Moderately heated vapor “A” leaves the top of solar blanket 1 and advances through piping to enter compressor 2 which raises its pressure/temperature. The hot vapor “A” exits compressor 2 and enters super heater 3 which dries saturated vapor “B” as it rises out of boiler 4. Vapor “A” continues through boiler 4 to enter expansion turbine 5 to assist motor 11 to drive compression turbine 2. Vapor “A” exits expansion turbine 5 and enters condenser 6 to liquefy saturated vapor “B” and exits condenser 6 and proceeds to enter solar flex blanket 1 to repeat the cycle again.

Regarding the saturated vapor loop “B”, liquid is vaporized in boiler 4 and raises to be dried or superheated in super heater 3 and enters expansion turbine 8 which rotates generator 10, then saturated vapor “B” exits expansion turbine 8 and enters brine chiller 9 to cool brine for specified purposes and enters condenser 6 to be condensed into liquid “C”. Liquefied vapor “C” is collected in bottom of condenser and piped to liquid feed pump 7 which operates as required by liquid level control 17 to maintain level in boiler 4 where liquid “C” is vaporized into “B” to repeat the saturated cycle again.

Pressure of dry vapor A in solar blanket 1 is maintained at 2 to 4 inches of water column by a non bleed low pressure regulator 18 and over pressure is prevented with low pressure control 16 operating pump 19 to store vapor A in recovery tank 20.

### Operation—FIG. 1

Starting at solar blanket 1, moderately heated vapor enters compressor 2 and enters heat exchanger super heater 3, progresses downward through baffling to enter heat exchanger boiler 4 and exits to drive expansion turbine 5 which recovers some of the expended energy of compression and enters condenser heat exchanger 6, and exits to return solar blanket 1.

Vapor pressure A, in solar blanket is maintained at two to four inches of water column with pressure regulator 18, and pressure control 16, which operates vapor pump 19.

Regarding the saturated high pressure vapor loop B & C. Liquid C boils into vapor B and rises into super heater 3, and exits to drive high pressure expansion turbine 8, and proceeds to brine chiller 9. Saturated vapor B leaves brine chiller 9 and enters condenser 6, heat exchanger to be condensed back into a liquid C, where pump 7, injects liquid C into boiler 4 as required by level control 17.

Refrigerant 22 can be utilized in low vapor circuit. A lower pressure refrigerant such as R-11 may be utilized in the high pressure circuit to prevent stresses to components.

Scroll design compressors may be substituted for centrifugal impellors by operating number 5&8 scrolls in reverse as expansion rotors.

Operation—FIG. 2 is identical except vapor B exits turbine 8 and directly enters condenser #6 and condenses into liquid C.

### DETAILED DESCRIPTION

### FIG. 1

There are two distinct gas (vapor) circuits in this embodiment. One is a dry low pressure circuit, and the other is a saturated high pressure circuit. Both loops containing either similar or dissimilar gases or refrigerants. The Flexible Thermal Solar Collector Blanket #1 is made of UV resistant vinyl welded sheets or other gas impermeable flex plastic sheeting. Sizes and capacities to be determined by computer modeling for heat exchangers 3, 4, 6 and 9, compressor 5, expansion turbines (rotors) 5 and 8, motor 11 generator 10, pumps 7 and 17. All components to be piped with copper, aluminum, or steel tubing and fittings.

A prototype thermal solar generator utilizes a 10 feet wide by 15 feet long waffle welded sheet vinyl collector blanket. Two, six inch openings at diagonal corners of the blanket to transition to metallic connections. The openings are capped and blanket is inflated with air to two inches of water column and spray four inches of rigid foam insulation on one side only. Two small automotive type turbo superchargers are modified and machined. One to connect to a speed increasing gearbox and a series wound DC motor. The other, turbo charger compressor housing and compressor impellor are machined away and the remaining exhaust turbine is coupled to a DC alternator. Gas tight rotary seals are required. Heat exchangers are rated at 50,000 BTU/hr. welded plate design. Other components are readily available from industrial supply houses. Make piping connections per schematic drawing. Provide a solar based operating program for motor 11. Provide a current conditioner for alternator output. Install solar blanket on an inclining support frame facing south to induce thermo siphoning of vapors in blanket. Assemble components behind collector support frame.

NOTE: The term “Saturated High Pressure” in this application can actually be very close to “Dry Low Pressure” vapor pressure to minimize stresses in heat exchangers.

A rigid solar collector may replace a flex blanket if it can rise and fall with a flexible vapor impermeable membrane.

FIG. 2, bypasses brine chiller and piped directly to condenser 6, from high pressure expansion turbine 8. All other functions are identical to FIG. 1.

The none condensing, or dry loop and a condensing, or saturated wet loop are charged with refrigerant #22 and #11 respectively or similar refrigerant gases.

Terminological conundrum: The vapor A such as R22 in the collector blanket loop remains non condensable in cold weather. Vapor B and liquid C is actually low pressure refrigerant such as R11 or similar low pressure gas. Therefore, the pressure differentials across any heat exchanger interior are negligible.

1. I claim as my invention, the use of compressors to increase the temperature of solar heated vapors and energy recovery expenders to assist motor and drive electric generator.
DEPENDENT CLAIMS: The concept of a flexible solar thermal collector blanket to minimize temperature extremes and costs and to maximize efficiency.
NOTES: Scroll design compressors can be substituted for turbo superchargers by switching connections to compressors effectively turning them into expanders or motors. Three compressors are required. One, to produce two or more times the volumetric displacement of motor assist expansion scroll. The size of generator expansion scroll to be computer modeled.
